(19) United States
(12) Patent Application Publication
(10) Pub. No.: US 2025/0369430 A1
(43) Pub. Date: Dec. 4, 2025

(54) WATER PUMP STRUCTURE AND ORAL IRRIGATOR

(71) Applicant: Fly Cat Electrical Co., Ltd., Shenzhen (CN)

(72) Inventor: Xiao Liu, Shenzhen (CN)

(21) Appl. No.: 18/797,666

(22) Filed: Aug. 8, 2024

(30) Foreign Application Priority Data
May 29, 2024 (CN) 202410684954.2

(51) Int. Cl. F04B 9/04; A61C 17/02; F04B 17/03

(52) U.S. Cl. CPC F04B 9/045; F04B 17/03; A61C 17/02

(57) ABSTRACT

A water pump structure and an oral irrigator are provided. The water pump structure includes a pump body, an inner liner, a piston, a connecting member, a connecting rod and a driving assembly, an end of the inner liner is provided in the pump body, and the inner liner is provided therein with a moving cavity; the piston is in sliding fit with an inner wall of the moving cavity; the connecting member has a first connecting end and a second connecting end opposite to each other, and the first connecting end is connected to the piston; the connecting rod is connected to the second connecting end; the connecting rod is formed thereon with a sliding groove; an opening direction of the sliding groove is the same as moving direction of the piston in the moving cavity; and the driving assembly includes a motor, a crank and a limiting member.

### CROSS-REFERENCE TO RELATED APPLICATION

The present disclosure claims the priority to the Chinese patent application with the filing No. 2024106849542 filed with the Chinese Patent Office on May 29, 2024 and entitled “WATER PUMP STRUCTURE AND ORAL IRRIGATOR”, the contents of which are incorporated herein by reference in entirety.

### TECHNICAL FIELD

The present disclosure relates to the technical field of oral cleaning devices, and particularly to a water pump structure and an oral irrigator.

### BACKGROUND ART

With the progress of science and technology and the development of social economy, oral care has received increasing attention from consumers. Oral irrigators are commonly used automatic oral-care products, and can clean teeth and gaps between teeth by means of flushing with a pulsed water flow.

A piston of existing oral irrigators, when performing reciprocating motion in a moving cavity, is easy to collide with an inner wall of the moving cavity, so that the oral irrigators have a problem of loud noise in a using process and further leads to poor user experience.

### SUMMARY

In order to overcome the defects in the prior art, the present disclosure provides a water pump structure and an oral irrigator.

The present disclosure provides the following technical solutions.

In the first aspect, the present disclosure provides a water pump structure, including:
a pump body;
an inner liner, wherein an end of the inner liner is provided in the pump body, and the inner liner is provided therein with a moving cavity;
a piston, wherein the piston is in sliding fit with an inner wall of the moving cavity;
a connecting member, wherein the connecting member has a first connecting end and a second connecting end opposite to each other, and the first connecting end is connected to the piston;
a connecting rod, wherein the connecting rod is connected to the second connecting end;
and the connecting rod is formed thereon with a sliding groove, wherein an opening direction of the sliding groove is the same as a moving direction of the piston in the moving cavity; and
a driving assembly, wherein the driving assembly includes a motor, a crank and a limiting member, wherein an output end of the motor is in transmission connection with the crank; the crank is rotatably provided in the connecting rod; the limiting member is provided to pass through the crank and the sliding groove; and the limiting member is in sliding fit with an inner wall of the sliding groove,
wherein when the motor drives the crank to rotate in the connecting rod, the crank is capable of driving the connecting rod to perform reciprocating motion.

In a possible embodiment, the connecting rod is further formed with a first chamber, and the second connecting end is fixed in the first chamber.

In a possible embodiment, the second connecting end is spherical in shape; and the first chamber is a spherical chamber matching the second connecting end.

In a possible embodiment, the second connecting end and the connecting rod are integrally formed.

In a possible embodiment, the connecting rod is further formed with a second chamber, the crank is rotatably provided in the second chamber, and the second chamber communicates with the sliding groove.

In a possible embodiment, the driving assembly further includes a driving member and a driven member; the output end of the motor is connected to the driving member, the driving member meshes with the driven member, the crank is fixed on the driven member, and the limiting member is provided to pass through the driven member, the crank and the sliding groove.

In a possible embodiment, the driven member is provided thereon with a fixing seat, the crank is fixed on the fixing seat; and the fixing seat is provided eccentrically with the crank.

In a possible embodiment, the piston is formed with a connecting cavity, and the first connecting end is engaged in the connecting cavity.

In a possible embodiment, the first connecting end includes a first connecting portion and a second connecting portion connected to each other; an end of the first connecting portion away from the second connecting portion is connected to the body of the connecting member; an outer diameter of the first connecting portion is larger than an inner diameter of an opening of the connecting cavity; and an outer diameter of at least a part of the second connecting portion is smaller than the inner diameter of the opening of the connecting cavity.

In the second aspect, the present disclosure further provides an oral irrigator, wherein the oral irrigator includes the above water pump structure.

Compared with the prior art, the present disclosure has the following beneficial effects:

For the water pump structure in the present disclosure, when the output end of the motor drives the crank to rotate in the connecting rod, the connecting rod can perform reciprocating motion under drive of the crank, so as to make the limiting member slide relative to the inner wall of the sliding groove, and cooperation between the inner wall of the sliding groove and the limiting member can limit a moving direction of the connecting rod, so that the moving direction of the connecting rod is the same as the opening direction of the sliding groove. As the opening direction of the sliding groove is the same as a direction of reciprocating motion of the piston in the moving cavity, when the connecting rod drives the piston to perform reciprocating motion in the moving cavity, the piston is not easy to collide with the inner wall of the moving cavity, and thus sound generated by the water pump structure when operating is further effectively reduced.

In order to make the above objectives, features and advantages of the present disclosure more obvious and understandable, preferred embodiments are particularly described in detail below with reference to drawings.

### BRIEF DESCRIPTION OF DRAWINGS

In order to more clearly illustrate technical solutions of embodiments of the present disclosure, drawings which need to be used in the embodiments will be briefly introduced below. It should be understood that the drawings merely show some embodiments of the present disclosure, and thus should not be considered as limitation to the scope. Those ordinarily skilled in the art still could obtain other relevant drawings according to these drawings, without using any inventive efforts.

FIG. 1 shows an exploded schematic view of a water pump structure according to an embodiment of the present disclosure;

FIG. 2 shows a perspective structural schematic view of the water pump structure according to an embodiment of the present disclosure;

FIG. 3 shows a perspective structural schematic view of a piston according to an embodiment of the present disclosure;

FIG. 4 shows a perspective structural schematic view of a connecting member according to an embodiment of the present disclosure;

FIG. 5 shows a perspective structural schematic view of a connecting rod according to an embodiment of the present disclosure;

FIG. 6 shows a perspective structural schematic view of a driven member and a crank according to an embodiment of the present disclosure; and

FIG. 7 shows an exploded schematic view of the water pump structure according to another embodiment of the present disclosure.

### Description of Signs of Main Elements:

100—water pump structure; 110—pump body; 120—inner liner; 121—fixing groove; 130—piston; 131—protruded portion; 132—connecting cavity; 140—connecting member; 141—body; 142—first connecting end; 143—second connecting end; 1431—first connecting portion; 1432—second connecting portion; 144—sealing groove; 150—connecting rod; 151—sliding groove; 152—first chamber; 153—second chamber; 160—driving assembly; 161—motor; 162—driving member; 163—driven member; 1631—fixing seat; 164—crank; 1641—through hole; 165—limiting member; 170—sealing member.

### DETAILED DESCRIPTION OF EMBODIMENTS

The embodiments of the present disclosure are described in detail below, and examples of the embodiments are shown in the drawings, wherein like or similar reference signs represent like or similar elements or elements having like or similar functions throughout. The embodiments described below with reference to the drawings are illustrative, merely for explaining the present disclosure, but should not be construed as limitation to the present disclosure.

In the description of the present disclosure, it should be understood that orientation or positional relationships indicated by the terms such as “central”, “longitudinal”, “transverse”, “length”, “width”, “thickness”, “upper”, “lower”, “front”, “back”, “left”, “right”, “vertical”, “horizontal”, “top”, “bottom”, “inner”, “outer”, “clockwise”, “counterclockwise”, “axial”, “radial”, and “circumferential” are based on orientation or positional relationships shown in the drawings and are merely intended to facilitate describing the present disclosure and simplifying the description, rather than indicating or implying that the indicated device or element must have a particular orientation or be constructed and operated in a specific orientation, and thus cannot be construed as limitation to the present disclosure.

Besides, the terms “first” and “second” are merely used for descriptive purpose, but should not be construed as indicating or implying importance in the relativity or implicitly indicating the number of an indicated technical feature. Thus, defining a feature with “first” or “second” may explicitly or implicitly mean that one or more such features are included. In the description of the present disclosure, “a plurality of” means two or more unless specifically defined otherwise.

In the present disclosure, unless explicitly specified and defined otherwise, the terms such as “mount”, “link”, “connect”, and “fix” should be construed in a broad sense. For example, it may be a fixed connection, a detachable connection, or an integral connection; it may be a mechanical connection, and also may be an electrical connection; it may be direct linking, indirect linking through an intermediary, or internal communication between two elements or interaction relationship between two elements. Specific meanings of the above terms in the present disclosure could be understood by those ordinarily skilled in the art according to specific situations.

In the present disclosure, unless otherwise explicitly specified and defined, a first feature being “on” or “under” a second feature may mean that the first feature is in direct contact with the second feature, or the first feature is in indirect contact with the second feature via an intermediary. Furthermore, the expression the first feature being “over”, “above” and “on top of” the second feature may be the case that the first feature is directly above or not directly above the second feature, or only means that the level of the first feature is higher than that of the second feature. The expression the first feature being “below”, “underneath” or “under” the second feature may be the case that the first feature is directly underneath or not directly underneath the second feature, or only means that the level of the first feature is lower than that of the second feature.

### Embodiment 1

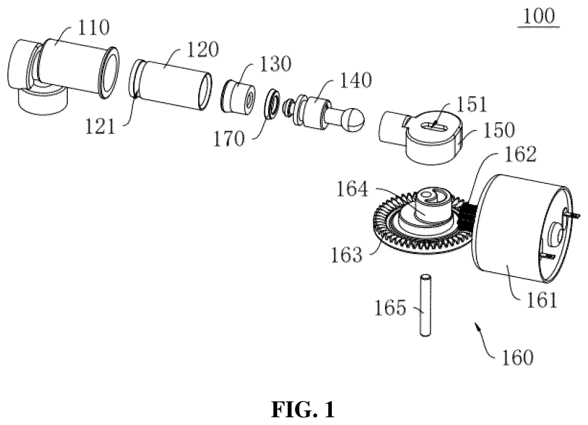

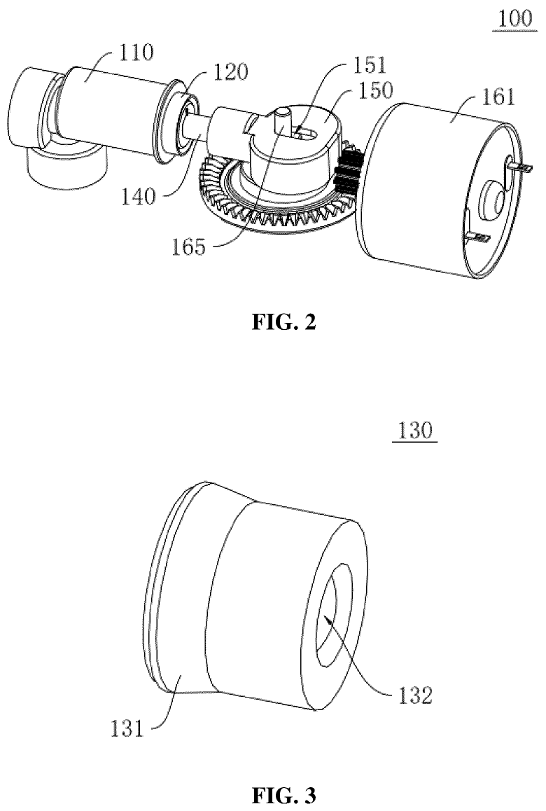

Referring to FIG. 1 and FIG. 2, an embodiment of the present disclosure provides a water pump structure 100. The water pump structure 100 is used in an oral irrigator.

The water pump structure 100 includes a pump body 110, an inner liner 120, a piston 130, a connecting member 140, a connecting rod 150 and a driving assembly 160.

In the above, an end of the inner liner 120 is provided in the pump body 110, and the inner liner 120 is provided therein with a moving cavity. The piston 130 is in sliding fit with an inner wall of the moving cavity, and the piston 130 can perform reciprocating motion in the moving cavity, so as to draw water in a water tank of the oral irrigator through the pump body 110.

The connecting member 140 has a first connecting end 142 and a second connecting end 143 opposite to each other, wherein the first connecting end 142 is used for connecting the piston 130, and the second connecting end is used for connecting the connecting rod 150.

The connecting rod 150 is formed thereon with a sliding groove 151, wherein an opening direction of the sliding groove 151 is the same as a direction of reciprocating motion of the piston 130 in the moving cavity.

The driving assembly 160 includes a motor 161, a crank 164 and a limiting member 165, wherein an output end of the motor 161 is in transmission connection with the crank 164; the crank 164 is rotatably provided in the connecting rod 150; the limiting member 165 is provided to pass through the crank 164 and the sliding groove 151; and the limiting member 165 is in sliding fit with an inner wall of the sliding groove 151.

The output end of the motor 161 can drive the crank 164 to rotate in the connecting rod 150, so that the crank 164 can drive the connecting rod 150 to perform reciprocating motion, and further make the connecting rod 150 drive, through the connecting member 140, the piston 130 to perform reciprocating motion in the moving cavity.

For the water pump structure 100 in the present embodiment, when the output end of the motor 161 drives the crank 164 to rotate, the connecting rod 150 can perform reciprocating motion under drive of the crank 164, so as to make the limiting member 165 slide relative to the inner wall of the sliding groove 151, and cooperation between the inner wall of the sliding groove 151 and the limiting member 165 can limit a moving direction of the connecting rod 150, so that the moving direction of the connecting rod 150 is the same as the opening direction of the sliding groove 151. As the opening direction of the sliding groove 151 is the same as a direction of reciprocating motion of the piston 130 in the moving cavity, when the connecting rod 150 drives the piston 130 to perform reciprocating motion in the moving cavity, the piston 130 is not easy to collide with the inner wall of the moving cavity, and thus sound generated by the water pump structure 100 when operating is further effectively reduced.

In some embodiments, referring to FIG. 1, the inner liner 120 has one end fixed in the pump body 110, and the other end exposed outside the pump body 110, so as to facilitate replacement and maintenance of the inner liner 120.

In some embodiments, an end of the inner liner 120 is formed thereon with a fixing groove 121, the pump body 110 is provided therein with a fixing block (not shown) matching the fixing groove 121, and the fixing block is engaged in the fixing groove 121, so that an end of the inner liner 120 is fixed in the pump body 110.

In some embodiments, the inner liner 120 is substantially cylindrical in shape; and the moving cavity is a cylindrical cavity.

The moving direction of the piston 130 in the moving cavity is parallel to an axial direction of the moving cavity.

In some embodiments, referring to FIG. 1 and FIG. 3, a protruded portion 131 is provided on a surface of the piston 130, and the protruded portion 131 is in sliding fit with the inner wall of the moving cavity, so as to reduce frictional resistance between the piston 130 and the inner wall of the moving cavity.

In some embodiments, in a natural state, a maximum outer diameter of the protruded portion 131 is larger than an inner diameter of the moving cavity, so as to ensure that the protruded portion 131 can be in interference fit with the inner wall of the moving cavity.

Further, the protruded portion 131 is provided at an end of the piston 130 away from the connecting member 140, and a height of the protruded portion 131 is gradually decreased from one end away from the connecting member 140 to the other end. When the protruded portion 131 performs reciprocating motion in the moving cavity, the protruded portion 131 is deformed towards a direction of the connecting member 140, so as to reduce the frictional resistance between the protruded portion 131 and the inner wall of the moving cavity.

Further, the connecting member 140 is provided thereon with a recessed area. When the protruded portion 131 performs reciprocating motion in the moving cavity, the protruded portion 131 is deformed towards a direction of the recessed area, and the recessed area provides space for deformation of the protruded portion 131.

In some embodiments, the connecting member 140 further includes a body 141, wherein the first connecting end 142 is provided at an end of the body 141, and the second connecting end 143 is provided at an end of the body 141 away from the first connecting end 142.

The first connecting end 142, the body 141 and the second connecting end 143 are fixedly connected by means of integral forming.

In some embodiments, referring to FIG. 3 and FIG. 4, the piston 130 is formed with a connecting cavity 132, and the first connecting end 142 is engaged in the connecting cavity 132, so that the piston 130 is connected to the connecting member 140.

In some embodiments, the first connecting end 142 includes a first connecting portion 1431 and a second connecting portion 1432 connected to each other, wherein an end of the first connecting portion 1431 away from the second connecting portion 1432 is connected to the body 141 of the connecting member 140.

An outer diameter of at least a part of the second connecting portion 1432 is smaller than an inner diameter of an opening of the connecting cavity 132, so as to facilitate the first connecting end 142 entering the connecting cavity 132 through the opening.

An outer diameter of the first connecting portion 1431 is larger than the inner diameter of the opening of the connecting cavity 132, so that the first connecting portion 1431 entering the connecting cavity 132 is difficult to disengage through the opening of the connecting cavity 132.

In some embodiments, referring to FIG. 3 and FIG. 4, the first connecting end 142 further includes a third connecting portion, wherein the third connecting portion is used for connecting the body 141 and the first connecting portion 1431. An outer diameter of the third connecting portion is smaller than the outer diameter of the protruded portion 131, and a position where the third connecting portion is located is the recessed area.

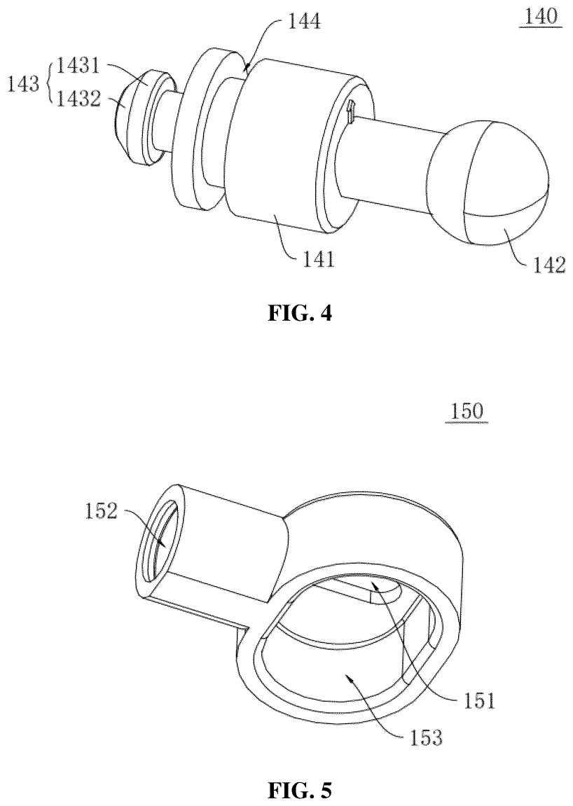

In some embodiments, referring to FIG. 4 and FIG. 5, the connecting rod 150 is further provided with a first chamber 152, and the second connecting end 143 is fixed in the first chamber 152, so that the connecting rod 150 is connected to the connecting member 140.

In some embodiments, a shape of the second connecting end 143 matches a shape of the first chamber 152, so that the second connecting end 143 is engaged in the first chamber 152.

Exemplarily, the second connecting end 143 is spherical in shape; and the first chamber 152 is a spherical chamber matching the second connecting end 143.

The shape of the second connecting end 143 and the shape of the first chamber 152 can be adjusted by an operator according to actual needs.

The second connecting end 143 is fixed in the first chamber 152 in such a manner that the connecting rod 150 is connected to the connecting member 140, so that a length of the connecting rod 150 is effectively reduced, the transmission efficiency is improved, and swinging of the connecting rod 150 during reciprocating motion is also effectively avoided.

In some embodiments, referring to FIG. 7, the second connecting end 143 and the connecting rod 150 are integrally formed, so that the connecting rod 150 is fixedly connected to the connecting member 140.

The second connecting end 143 and the connecting rod 150 are integrally formed, which can also improve the transmission efficiency of the piston 130, and reduce the collision of the piston 130 when performing reciprocating motion in the moving cavity, with the inner wall of the moving cavity.

In some embodiments, referring to FIG. 4 and FIG. 5, the connecting rod 150 is further formed with a second chamber 153, wherein the crank 164 is rotatably provided in the second chamber 153, and the second chamber 153 communicates with the sliding groove 151.

In some embodiments, referring to FIG. 1 and FIG. 2, the driving assembly 160 further includes a driving member 162 and a driven member 163; the output end of the motor 161 is connected to the driving member 162, the driving member 162 meshes with the driven member 163, the crank 164 is fixed on the driven member 163, and the limiting member 165 is provided to pass through the driven member 163, the crank 164 and the sliding groove 151.

The driving member 162 is provided thereon with first teeth, the driven member 163 is provided thereon with second teeth matching the first teeth, and the first teeth mesh with the second teeth. When the output end of the motor 161 drives the driving member 162 to rotate, the driving member 162 drives the driven member 163 to rotate through meshing with the driven member 163, so that the driven member 163 drives the crank 164 to rotate in the second chamber 153 in the connecting rod 150.

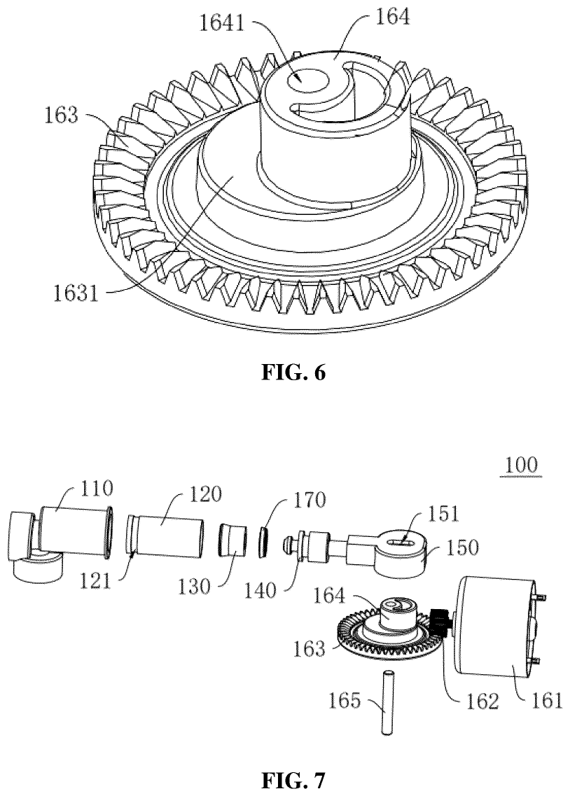

In some embodiments, referring to FIG. 1 and FIG. 6, the driven member 163 is provided thereon with a fixing seat 1631, and the crank 164 is fixed on the fixing seat 1631. The fixing seat 1631 and the crank 164 are eccentrically provided, so that the crank 164 promotes, when rotating in the second chamber 153, the connecting rod to move, and thus the limiting member 165 can slide relative to the inner wall of the sliding groove 151.

In some embodiments, the crank 164, the fixing seat 1631 and the driven member 163 are fixedly connected by means of integral forming.

In some embodiments, the crank 164 is formed with a through hole 1641, and the limiting member 165 is fixed in the through hole 1641.

Exemplarily, the limiting member 165 is in interference fit with an inner wall of the through hole 1641.

In some embodiments, the limiting member 165 is a cylindrical limiting member, and the sliding groove 151 is a waist-shaped groove.

In some embodiments, the output end of the motor 161 has a first operating state in a first direction and a second operating state in a second direction, the first direction being opposite the second direction.

Exemplarily, the first direction is a clockwise direction, the second direction is a counterclockwise direction, and the output end of the motor 161 alternately rotates in the first direction and the second direction, so that the connecting rod 150 drives the piston 130 to perform reciprocating motion in the moving cavity.

In some embodiments, referring to FIG. 1 and FIG. 4, the water pump structure 100 further includes a sealing member 170, a sealing groove 144 is formed on the body 141 of the connecting member 140, and the sealing member 170 is provided in the sealing groove 144.

The sealing member 170 is in sliding fit with the inner wall of the moving cavity of the inner liner 120. The sealing member 170 is used to prevent liquid from leaking from the moving cavity.

### Embodiment 2

The present disclosure further provides an oral irrigator, including the water pump structure 100 of any of the above embodiments.

The oral irrigator provided in the present embodiment has the water pump structure 100 provided in any of the above embodiments, and thus has all the beneficial effects of the water pump structure 100 provided in any of the above embodiments, which are not repeated herein.

In the description of the present specification, description with reference to the terms such as “an embodiment”, “some embodiments”, “example”, “specific example”, or “some examples” mean that specific features, structures, materials or characteristics described in combination with this embodiment or example are included in at least one embodiment or example of the present disclosure. In the present specification, schematic expressions of the above terms do not necessarily refer to the same embodiment or example. Moreover, the specific features, structures, materials or characteristics described can be combined in any suitable manner in any one or more embodiments or examples. Besides, those skilled in the art could incorporate and combine different embodiments or examples and features in different embodiments or examples described in the present specification, without contradicting each other.

Although the embodiments of the present disclosure are shown and described in the above, it could be understood that the above embodiments are illustrative, and should not be construed as limitation to the present disclosure. Those ordinarily skilled in the art could change, modify, substitute and vary the above embodiments within the scope of the present disclosure.

What is claimed is:

1. A water pump structure, comprising:
a pump body;
an inner liner, wherein an end of the inner liner is provided in the pump body, and the inner liner is provided therein with a moving cavity;
a piston, wherein the piston is in sliding fit with an inner wall of the moving cavity;
a connecting member, wherein the connecting member has a first connecting end and a second connecting end opposite to each other, and the first connecting end is connected to the piston;
a connecting rod, wherein the connecting rod is connected to the second connecting end; and the connecting rod is formed thereon with a sliding groove, wherein an opening direction of the sliding groove is the same as a moving direction of the piston in the moving cavity; and
a driving assembly, wherein the driving assembly comprises a motor, a crank and a limiting member, wherein an output end of the motor is in transmission connection with the crank; the crank is rotatably provided in the connecting rod; the limiting member is provided to pass through the crank and the sliding groove; and the limiting member is in sliding fit with an inner wall of the sliding groove,
wherein when the motor drives the crank to rotate in the connecting rod, the crank is capable of driving the connecting rod to perform reciprocating motion.

2. The water pump structure according to claim 1, wherein the connecting rod is further formed with a first chamber, and the second connecting end is fixed in the first chamber.

3. The water pump structure according to claim 2, wherein the second connecting end is spherical in shape; and the first chamber is a spherical chamber matching the second connecting end.

4. The water pump structure according to claim 1, wherein the second connecting end and the connecting rod are integrally formed.

5. The water pump structure according to claim 1, wherein the connecting rod is further formed with a second chamber, the crank is rotatably provided in the second chamber, and the second chamber communicates with the sliding groove.

6. The water pump structure according to claim 1, wherein the driving assembly further comprises a driving member and a driven member; the output end of the motor is connected to the driving member, the driving member meshes with the driven member, the crank is fixed on the driven member, and the limiting member is provided to pass through the driven member, the crank and the sliding groove.

7. The water pump structure according to claim 6, wherein the driven member is provided thereon with a fixing seat, the crank is fixed on the fixing seat; and the fixing seat is provided eccentrically with the crank.

8. The water pump structure according to claim 1, wherein the piston is formed with a connecting cavity, and the first connecting end is engaged in the connecting cavity.

9. The water pump structure according to claim 8, wherein the first connecting end comprises a first connecting portion and a second connecting portion connected to each other; an end of the first connecting portion away from the second connecting portion is connected to a body of the connecting member; an outer diameter of the first connecting portion is larger than an inner diameter of an opening of the connecting cavity; and an outer diameter of at least a part of the second connecting portion is smaller than the inner diameter of the opening of the connecting cavity.

10. An oral irrigator, comprising the water pump structure according to claim 1.

11. The water pump structure according to claim 2, wherein the connecting rod is further formed with a second chamber, the crank is rotatably provided in the second chamber, and the second chamber communicates with the sliding groove.

12. The water pump structure according to claim 3, wherein the connecting rod is further formed with a second chamber, the crank is rotatably provided in the second chamber, and the second chamber communicates with the sliding groove.

13. The water pump structure according to claim 4, wherein the connecting rod is further formed with a second chamber, the crank is rotatably provided in the second chamber, and the second chamber communicates with the sliding groove.

14. The water pump structure according to claim 2, wherein the driving assembly further comprises a driving member and a driven member; the output end of the motor is connected to the driving member, the driving member meshes with the driven member, the crank is fixed on the driven member, and the limiting member is provided to pass through the driven member, the crank and the sliding groove.

15. The water pump structure according to claim 3, wherein the driving assembly further comprises a driving member and a driven member; the output end of the motor is connected to the driving member, the driving member meshes with the driven member, the crank is fixed on the driven member, and the limiting member is provided to pass through the driven member, the crank and the sliding groove.

16. The water pump structure according to claim 4, wherein the driving assembly further comprises a driving member and a driven member; the output end of the motor is connected to the driving member, the driving member meshes with the driven member, the crank is fixed on the driven member, and the limiting member is provided to pass through the driven member, the crank and the sliding groove.

17. The water pump structure according to claim 2, wherein the piston is formed with a connecting cavity, and the first connecting end is engaged in the connecting cavity.

18. The water pump structure according to claim 3, wherein the piston is formed with a connecting cavity, and the first connecting end is engaged in the connecting cavity.

19. The water pump structure according to claim 4, wherein the piston is formed with a connecting cavity, and the first connecting end is engaged in the connecting cavity.

20. The oral irrigator according to claim 10, wherein the connecting rod is further formed with a first chamber, and the second connecting end is fixed in the first chamber.
